(19) United States
(12) Patent Application Publication
(10) Pub. No.: US 2026/0361669 A1
(43) Pub. Date: Nov. 12, 2026

(54) INFORMATION PROCESSING

(71) Applicant: Beijing Zitiao Network Technology Co., Ltd., Beijing (CN)

(72) Inventors: Zhekai Ye, Beijing (CN); Zhihao Jin, Beijing (CN)

(21) Appl. No.: 19/671,628

(22) Filed: May 8, 2026

(30) Foreign Application Priority Data
May 9, 2025 (CN) 202510600269.1

(51) Int. Cl. H04L 51/02; H04L 51/04; H04L 51/216

(52) U.S. Cl. CPC H04L 51/02; H04L 51/04; H04L 51/216

(57) ABSTRACT

The disclosure relates to information processing. An method includes: determining, from a first question-answering model local to a client device and a second question-answering model at a server device, a question-answering model in response to obtaining a question message in a question-answering chat; determining whether a set of historical messages in the question-answering chat has not been synchronized to the server device in response to the second question-answering model determined as the question-answering model; sending, in response to the set of historical messages not being synchronized, the question message and at least one of the set of historical messages to the server device, each historical message including a historical question message or a historical reply message in the question-answering chat that is generated by the first question-answering model based on a corresponding historical question message; and receiving, from the server device, a reply message corresponding to the question message.

### CROSS-REFERENCE

This application claims the benefit of CN Patent Application No. 202510600269.1, filed on May 09, 2025, entitled "INFORMATION PROCESSING METHOD, APPARATUS, STORAGE MEDIUM, AND PROGRAM PRODUCT", which is hereby incorporated by reference in its entirety.

### FIELD

Example embodiments of the present disclosure generally relate to the field of computers, and in particular, to a method, an apparatus, an electronic device, a computer-readable storage medium, and a computer program product for information processing.

### BACKGROUND

With the development of Internet technologies, more and more applications or platforms provide a question-answering function, which brings great convenience to users. An application or platform that is installed on a client device and has a question-answering function may use a machine learning model to provide a question-answering service for a user. The machine learning model used may be a machine learning model local to the client device or a remote machine learning model accessed through a network connection.

### SUMMARY

In a first aspect of the present disclosure, a method for information processing is provided. The method is implemented at a client device. The method includes: determining, from a first question-answering model local to the client device and a second question-answering model at a server device, a target question-answering model in response to obtaining a question message in a question-answering chat; determining whether there is a set of historical messages in the question-answering chat that have not been synchronized to the server device in response to the second question-answering model being determined as the target question-answering model; sending, in response to there being the set of historical messages that have not been synchronized, the question message and at least one of the set of historical messages to the server device, each historical message including a historical question message or a historical reply message in the question-answering chat, the historical reply message being generated by the first question-answering model based on a corresponding historical question message; and receiving, from the server device, a reply message corresponding to the question message, where the reply message is determined by the second question-answering model based at least on the question message.

In a second aspect of the present disclosure, a method for information processing is provided. The method is implemented at a server device. The method includes: receiving, from a client device, a question message in a question-answering chat and at least one of a set of historical messages in the question-answering chat, the set of historical messages having not been previously synchronized to the server device; determining, by a second question-answering model at the server device, a reply message for the question message based on the question message and the at least one historical message; and sending the reply message to the client device.

In a third aspect of the present disclosure, an apparatus for information processing is provided. The apparatus is implemented at a client device. The apparatus includes: a question-answering model determination module configured to determine, from a first question-answering model local to the client device and a second question-answering model at a server device, a target question-answering model in response to obtaining a question message in a question-answering chat; a historical message determination module configured to determine whether there is a set of historical messages in the question-answering chat that have not been synchronized to the server device in response to the second question-answering model being determined as the target question-answering model; a question message sending module configured to send, in response to there being the set of historical messages that have not been synchronized, the question message and at least one of the set of historical messages to the server device, each historical message including a historical question message or a historical reply message in the question-answering chat, the historical reply message being generated by the first question-answering model based on a corresponding historical question message; and a reply message receiving module configured to receive, from the server device, a reply message corresponding to the question message, where the reply message is determined by the second question-answering model based at least on the question message.

In a fourth aspect of the present disclosure, an apparatus for information processing is provided. The apparatus is implemented at a server device. The apparatus includes: a question message receiving module configured to receive, from a client device, a question message in a question-answering chat and at least one of a set of historical messages in the question-answering chat, the set of historical messages having not been previously synchronized to the server device; a reply message determination module configured to determine, by a second question-answering model at the server device, a reply message for the question message based on the question message and the at least one historical message; and a reply message sending module configured to send the reply message to the client device.

In a fifth aspect of the present disclosure, an electronic device is provided. The electronic device includes at least one processor; and at least one memory, the at least one memory being coupled to the at least one processor and storing instructions executable by the at least one processor, the instructions, when executed by the at least one processor, causing the electronic device to perform the method of the first aspect or the second aspect.

In a sixth aspect of the present disclosure, a non-transitory computer-readable storage medium is provided. The non-transitory computer-readable storage medium stores computer-executable instructions, the computer-executable instructions, when executed by a processor, implementing the method of the first aspect or the second aspect.

In a seventh aspect of the present disclosure, a computer program product is provided. The computer program product includes computer-executable instructions, the computer-executable instructions, when executed by a processor, implementing the method of the first aspect or the second aspect.

It should be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure may be implemented;

FIG. 2 shows a schematic diagram of an example architecture of information processing according to some embodiments of the present disclosure;

FIG. 3 shows a schematic diagram of an example of information processing according to some embodiments of the present disclosure;

FIG. 4 shows a schematic diagram of a signaling flow for information processing according to some embodiments of the present disclosure;

FIG. 5 shows a flowchart of a method for information processing implemented at a client device according to some embodiments of the present disclosure;

FIG. 6 shows a flowchart of a method for information processing implemented at a server device according to some embodiments of the present disclosure;

FIG. 7 shows an example structural block diagram of an apparatus for information processing implemented at a client device according to some embodiments of the present disclosure;

FIG. 8 shows an example structural block diagram of an apparatus for information processing implemented at a server device according to some embodiments of the present disclosure; and

FIG. 9 shows a block diagram of an electronic device capable of implementing one or more embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be interpreted as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". The following may also include other explicit and implicit definitions.

Herein, unless explicitly stated, the execution of a step "in response to A" does not mean that the step is executed immediately after "A", but may include one or more intermediate steps.

It may be understood that the data involved in the technical solution (including but not limited to the data itself, acquisition, use, storage or deletion of the data) should comply with requirements of corresponding laws, regulations and related provisions.

It may be understood that before using the technical solutions disclosed in the embodiments of the present disclosure, the user shall be informed of the type, range of use, use scenarios, etc. of personal information involved in the present disclosure and obtain the authorization of the user in an appropriate manner according to relevant laws and regulations.

For example, in response to receiving an active request from a user, prompt information is sent to the user to clearly prompt the user that the requested operation will require access to and use of the user’s personal information, so that the user may independently choose whether to provide the personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select "agree" or "disagree" to provide the personal information to the electronic device.

It may be understood that the above process of notifying and obtaining user authorization is only illustrative, and does not limit the implementations of the present disclosure. Other methods that meet relevant laws and regulations may also be applied to the implementations of the present disclosure.

As used herein, the term "model" may learn a correlation between corresponding inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, a "model" may also be referred to as a "machine learning model", a "learning model", a "machine learning network" or a "learning network", which terms are used interchangeably herein.

Generally speaking, machine learning may roughly include three stages, namely, a training stage, a testing stage, and an application stage (also referred to as an inference stage). In the training stage, a given model may be trained using a large amount of training data, and a parameter value is continuously iteratively updated until the model may obtain consistent inference that meets an expected objective from the training data. Through training, the model may be considered to be able to learn a correlation (also referred to as a mapping from input to output) from input to output from the training data. The parameter value of the trained model is determined. In the testing stage, a test input is applied to the trained model to test whether the model may provide a correct output, thereby determining the performance of the model. The testing stage may sometimes be incorporated into the training stage. In the application or inference stage, the trained model may be used to process an actual model input based on the parameter value obtained through training, to determine a corresponding model output.

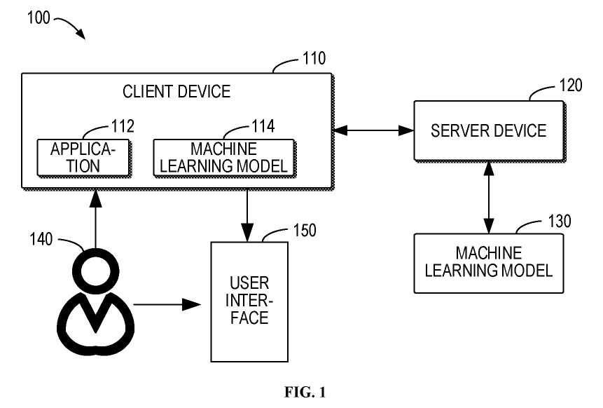

FIG. 1 shows a schematic diagram of an example environment 100 in which the embodiments of the present disclosure may be implemented. In the example environment 100, an application 112 is installed on a client device 110. A user 140 may interact with the application 112 via the client device 110 and/or an attachment device of the client device 110. For example, the application 112 may collect a voice of the user 140 via a voice collecting device (e.g., a microphone) of the client device 110, and the application 112 may collect an image of the user 140 via an image collecting device (e.g., a camera) of the client device 110.

In the embodiments of the present disclosure, the application 112 may be any appropriate application with a voice processing function. For example, the application 112 may be a social application, a chat application, a media item application, and so on. For example, the application 112 may provide a digital assistant for human-computer conversation. The digital assistant supports a text conversation service, a voice conversation service, and a content conversation in other modes with the user 140. In some embodiments, the application 112 or the digital assistant therein may use a machine learning model. For example, the application 112 or the digital assistant therein may use the machine learning model to provide a question-answering service for the user 140. A reply of the digital assistant to the user may be determined based on a model output of the machine learning model.

The machine learning model may be a machine learning model (e.g., the machine learning model 114) deployed locally on the client device 110, or may be a machine learning model (e.g., the machine learning model 130) deployed on another device. The machine learning model deployed locally on the client device 110, for example, the machine learning model 114, may be referred to as an offline machine learning model. The machine learning model deployed on another device, for example, the machine learning model 130, may be referred to as an online machine learning model.

Both the machine learning model 114 and the machine learning model 130 may be based on any appropriate model structure, including but not limited to a transformer model, a convolutional neural network (CNN), a recurrent neural network (RNN), a deep neural network (DNN), and so on. In some embodiments, the machine learning model 114 and/or the machine learning model 130 may be based on a language model (LM). The language model may have a question-answering capability by learning from a large amount of corpus.

In some embodiments, the machine learning model 114 and/or the machine learning model 130 may be content generation models, which may generate corresponding desired model outputs based on model inputs. In some embodiments, the machine learning model based on the language model may receive a model input in a text modality (e.g., a natural language and/or a machine language) and/or a model input in a non-text modality (e.g., an image, a voice, a video, etc.), and generate a desired output based on the model input and a prompt. The prompt here is used to guide the machine learning model to generate a model output that may solve a user need indicated by the model input.

In an application scenario for supporting user question-answering, a question message input by the user 140 may be provided to the machine learning model 114 and/or the machine learning model 130 as at least a part of the model input (the other part may include the prompt). Based on the model output, a reply message corresponding to the question message may be generated and provided to the user 140. The question message may be a message of a voice type or a message of a text type. In the embodiments of the present disclosure, the question message of the voice type may be referred to as a question voice, and the question message of the text type may be referred to as a question text. Correspondingly, the reply message may also be a message of the voice type or a message of the text type. In the embodiments of the present disclosure, the reply message of the voice type may be referred to as an answer voice, and the reply message of the text type may be referred to as an reply text. It may be understood that, in this article, only the question voice, the question text, the answer voice, and the reply text are used as examples, and the question message and the reply message may also include any other appropriate type of message, such as a message of an image type, a message of a file type, and so on.

It should be noted that the machine learning model 114 and the machine learning model 130 in FIG. 1 may each include one or more machine learning models. If multiple machine learning models are included, the functions, structures, uses, etc. of the multiple machine learning models may be the same or different. In some embodiments, in the answering scenario, the machine learning model 114 and/or the machine learning model 130 may at least include a machine learning model for performing question-answering (which may be referred to as a question-answering model for short). In some embodiments, the input of the question-answering model is the question text, and the output is the corresponding reply text. In some embodiments, in the answering scenario, because the question message may be the question voice, and the user expects to obtain the answer voice, the machine learning model 114 and/or the machine learning model 130 may further include a machine learning model for performing automatic speech recognition (ASR) on the question voice (which may also be referred to as a machine learning model for performing voice-to-text, and may also be referred to as an ASR model for short), and a machine learning model for performing text-to-speech (TTS) on the reply text (which may also be referred to as a machine learning model for performing text-to-speech, and may be referred to as a TTS model for short). The input of the ASR model is voice, and the output is text. The input of the TTS model is text, and the output is the corresponding voice.

In the environment 100, if the application 112 is active, the client device 110 may present a user interface 150 of the application 112. The user interface 150 may include various interfaces that may be provided by the application 112, such as a conversation interface between a user and a digital assistant (in which a current conversation and a historical conversation, including text conversation content, may be presented), and so on. In some embodiments, the client device 110 may play a voice via the user interface 150, and the voice may include a question voice from the user and an answer voice for the question voice.

In some embodiments, the client device 110 communicates with the server device 120 to implement provision of a service of the application 112. For example, the server device 120 may invoke the machine learning model 130 to support a question-answering function between the application 112 and the user 140 based on an output of the machine learning model 130.

The client device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. In some embodiments, the client device 110 may also support any type of interface for the user (such as a "wearable" circuit, etc.).

The server device 120 may be an independent physical server, a server cluster or a distributed system composed of multiple physical servers, or a cloud server that provides basic cloud computing services such as a cloud service, a cloud database, cloud computing, a cloud function, cloud storage, a network service, cloud communication, a middleware service, a domain name service, a security service, a content delivery network, and a big data and artificial intelligence platform. The server device 120 may include, for example, a computing system/server, such as a mainframe, an edge computing node, a computing device in a cloud environment, and so on. For example, the server device 120 may be implemented based on a cloud environment.

It should be understood that the structures and functions of the elements in the environment 100 are described only for the purpose of illustration, without suggesting any limitation to the scope of the present disclosure.

As mentioned above, an application or platform installed on a client device and having a question-answering function may use a trained machine learning model to provide a question-answering service for a user. The machine learning model may be a machine learning model local to the client device, or may be a remote machine learning model accessed through a network connection. During a question-answering chat, the remote machine learning model may sometimes be invoked to provide the question-answering service, and sometimes the local machine learning model may be used to provide the question-answering service. Therefore, in a question-answering chat, there may be a case that reply messages corresponding to some question messages are determined by the remote machine learning model, and reply messages corresponding to other question messages are determined by the local machine learning model.

In the scenario of question-answering chat, in order to improve the accuracy of determining a reply message for a question message using a machine learning model, historical context of the same question-answering chat, for example, at least one historical message, is usually provided to the machine learning model. Since the information stored by the machine learning models deployed on different devices is independent of each other, the historical context obtained by the machine learning models deployed on different devices will be different, which may affect the accuracy of the determined reply message. Therefore, in the case of using multiple models to support question-answering, it is desired to implement information synchronization for the machine learning models on different devices.

In view of this, according to the embodiments of the present disclosure, an improved solution for information processing is provided. According to the solution of the embodiments of the present disclosure, after obtaining a question message in a question-answering chat, a client device selects, from a first question-answering model local to the client device and a second question-answering model at a server device, a target question-answering model for processing a current question message. If it is determined that the second question-answering model at the server device is to be selected, the client device determines whether there is a set of historical messages in the question-answering chat that have not been synchronized to the server device. If there is the set of historical messages that have not been synchronized, the client device sends the question message and at least one of the set of historical messages to the server device, and receives, from the server device, a reply message corresponding to the question message. At the server device, the server device receives, from the client device, the question message in the question-answering chat and at least one of the set of historical messages in the question-answering chat that have not been previously synchronized. In this way, the server device determines, using the second question-answering model, a reply message for the question message based on the question message and the at least one historical message, and sends the reply message to the client device.

In this way, when it is necessary to use the model at the server device to process a question, the client device takes the initiative to send at least part of historical messages that have not been synchronized locally to the server device. This may ensure that, in the case that the information between the client device and the server device is not fully synchronized, the model at the server device also has sufficient and correct conversation historical context to process the current question, thereby giving a correct answer. This may implement information synchronization between the client device and the server device, so that both the question-answering model local to the client device and the question-answering model at the server device may determine answers based on the same historical information, which facilitates the improvement of the accuracy of answers. In addition, in order to ensure the efficiency of current question-answering, in the case that there are a relatively large number of historical messages that have not been synchronized locally on the client device, it is not necessary to upload all the historical messages that have not been synchronized at once, but the latest part of historical messages that are more concerned in the model processing are selected and uploaded.

Some example embodiments of the present disclosure will be further described below with reference to the drawings.

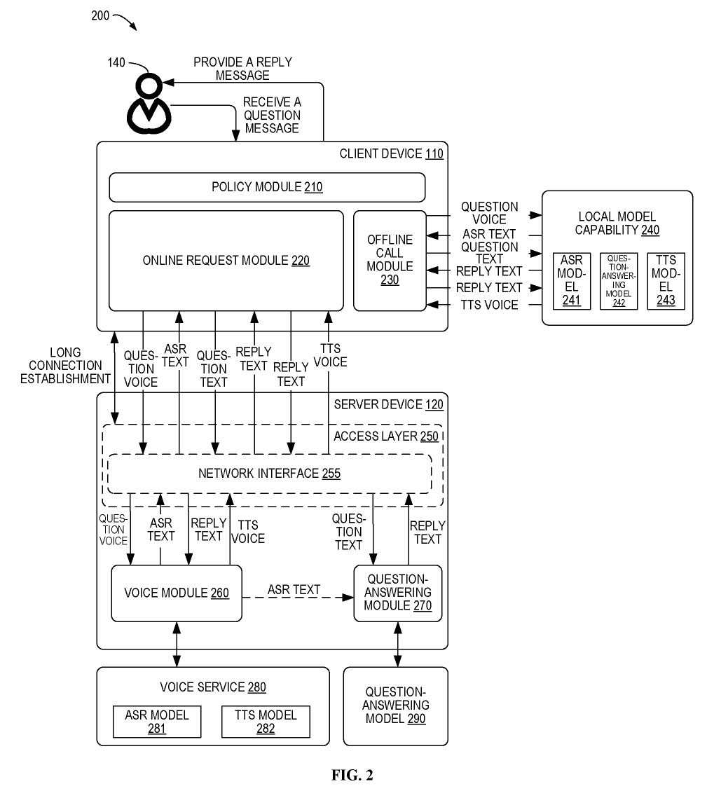

FIG. 2 shows a schematic diagram of an example architecture 200 for speech processing according to some embodiments of the present disclosure. For the convenience of discussion, the architecture 200 will be described with reference to the environment 100 of FIG. 1. It should be noted that the operations performed by the client device 110 described above and the operations performed by the client device 110 described subsequently may be specifically performed by a related application (for example, the application 112) installed on the client device 110. In some embodiments, the operations performed on the client device 110 may be completed with the assistance of the server device 120.

As shown in FIG. 2, the architecture 200 involves the client device 110 and the server device 120. The client device 110 may include a policy module 210, an online request module 220, and an offline call module 230. The offline call module 230 is configured to interact with a local model capability 240, and the local model capability 240 may provide a machine learning model (for example, at least including an ASR model 241, a question-answering model 242, and a TTS model 243) deployed locally on the client device 110. The ASR model 241 may also be referred to as a first speech recognition model, the question-answering model 242 may also be referred to as a first question-answering model, and the TTS model 243 may also be referred to as a first speech synthesis model.

The online request module 220 is configured to interact with the server device 120 to invoke a machine learning model deployed at the server device 120. The server device 120 may include an access layer 250, a voice module 260, and a question-answering module 270. The server device 120 interacts with the client device 110 via the access layer 250. The voice module 260 is configured to interact with a voice service 280, and the voice service 280 may provide a voice processing model (for example, including an ASR model 281 and a TTS model 282) deployed at the server device 120. The ASR model 281 may also be referred to as a second speech recognition model, and the TTS model 282 may also be referred to as a second speech synthesis model. The question-answering module 270 is configured to interact with a question-answering model 290. The question-answering model 290 may also be referred to as a second question-answering model.

During the question-answering process, the client device 110 may receive a question message from the user 140 in a question-answering chat . The question-answering chat may be, for example, a chat between a user and a digital assistant, or a chat between a user and a model-related application. Messages in the question-answering chat may be received and/or presented in any appropriate chat window. The client device 110 may determine, using the policy module 210, at least one policy for processing the question message in response to receiving the question message. The at least one policy may include at least a question-answering distribution policy, and the question-answering distribution policy may be used to determine which question-answering model to select to determine a corresponding reply message based on the question message. In some embodiments, the at least one policy may further include an ASR distribution policy and a TTS distribution policy. If the question message includes a question voice, the ASR distribution policy may be used to determine which ASR model to select to perform an ASR function on the question voice. If the reply message includes an answer voice, the TTS distribution policy may be used to determine which TTS model to select to perform a TTS function on an reply text.

It should be noted that it should be noted that the interaction between the client device 110 and the server device 120 usually takes a certain amount of time. In addition, the model size of the machine learning model deployed locally on the client device 110 is usually smaller than the model size of the machine learning model deployed at the server device 120. The model size of each machine learning model is associated with a parameter scale, a model structure complexity, etc. of the machine learning model. Generally speaking, the greater the parameter scale or the more complex the structure of the machine learning model, the larger the model size of the machine learning model. The larger the model size of the machine learning model, the greater the resource overhead required, and the resource overhead includes but is not limited to computing resources, memory resources, time-consuming, and so on. Generally speaking, the accuracy of a task performed by a machine learning model with a larger model size is greater than the accuracy of a task performed by a machine learning model with a smaller model size. For example, for the same question message, the accuracy of the reply message determined by the question-answering model 290 may be higher than the accuracy of the reply message determined by the question-answering model 242.

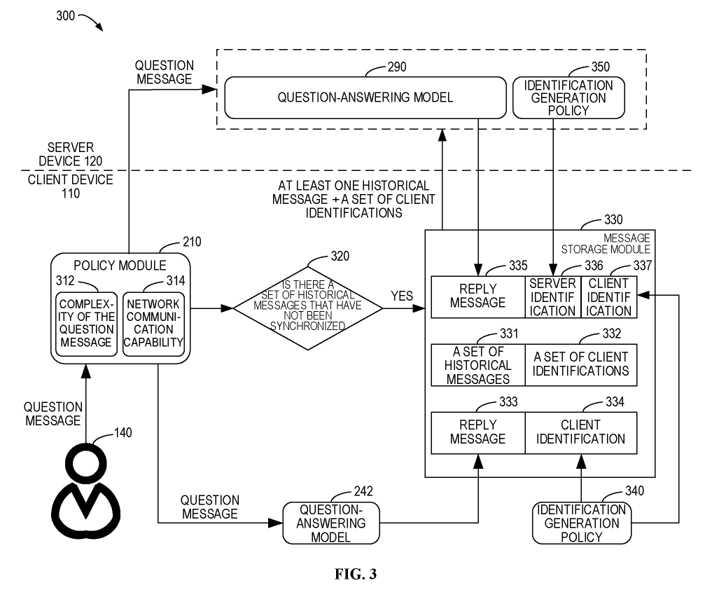

Reference is made to FIG. 3, which shows a schematic diagram of an example 300 of information processing according to some embodiments of the present disclosure. As shown in FIG. 3, in some embodiments, the policy module 210 may determine a complexity 312 of the question message, and determine a question-answering policy based on the complexity 312 of the question message. Herein, the machine learning model used to process the current question message and determine the reply message is sometimes referred to as a target question-answering model. The policy module 210 may determine a target question-answering model from the question-answering model 242 and the question-answering model 290 based on at least one of the complexity 312 of the question message and the network communication capability 314.

The policy module 210 may determine the complexity 312 of the question message in any appropriate manner. For example, the policy module 210 may determine the complexity 312 of the question message based on a predetermined determination rule. For another example, the policy module 210 may determine the complexity 312 of the question message by using a trained machine learning model (e.g., an evaluation model deployed locally).

The policy module 210 may further store a predetermined complexity requirement. The policy module 210 may determine that the question message is relatively simple in response to the complexity 312 of the question message not satisfying the complexity requirement, and determine that the corresponding reply message may be determined by using the question-answering model 242 local to the client device 110, that is, determine the question-answering model 242 as the target question-answering model. The policy module 210 may further determine that the question message is relatively complex in response to the complexity 312 of the question message satisfying the complexity requirement, and determine that the reply message corresponding to the question message needs to be determined by using the question-answering model 290 at the server device 120, that is, determine the question-answering model 290 as the target question-answering model.

In this way, the policy module 210 may use the local question-answering model 242 to determine the reply message when the question message is relatively simple, which may increase the speed of determining the reply message and reduce resource consumption. The policy module 210 may use the question-answering model 290 at the server device 120 to determine the reply message when the question message is relatively complex, which may improve the accuracy of the determined reply message.

Alternatively or additionally, in some embodiments, the policy module 210 may further determine a network communication capability 314 between the client device 110 and the server device 120, and determine a question-answering policy based on the network communication capability 314. The network communication capability 314 may be determined based on one or more factors such as network signal strength, network link speed, network delay, etc., and it may be used to measure the networking situation between the client device 110 and the server device 120. The policy module 210 may detect the network communication capability 314 between the client device 110 and the server device 120, for example, by using a network probe.

In some embodiments, the policy module 210 may further determine a capability level corresponding to the network communication capability 314 based on a detection result. For example, the policy module 210 may pre-determine a correspondence between the network communication capability 314 and the capability level. For example, the policy module 210 may determine that the network communication capability 314 is at a capability level A when it is in an interval [a1, b1); determine that the network communication capability 314 is at a capability level B when it is in an interval [a2, b2); determine that the network communication capability 314 is at a capability level C when it is in an interval [a3, b3); and so on. It should be understood that there are no identical values in different intervals. For example, there are no identical values in the interval [a1, b1) and the interval [a2, b2).

The policy module 210 may determine a question-answering policy for the question message based on the network communication capability 314 between the client device 110 and the server device 120. In some embodiments, the policy module 210 may determine that there is currently no network communication or the current network communication is poor in response to the network communication capability 314 being below a first capability level, and then determine that the corresponding reply message may be determined by using the question-answering model 242 local to the client device 110, that is, determine the question-answering model 242 as the target question-answering model. In some embodiments, the policy module 210 may determine that there is currently network communication or the current network communication is good in response to the network communication capability 314 exceeding a second capability level.

In this case, the policy module 210 may determine that the corresponding reply message may be determined by using the question-answering model 242 local to the client device 110, or may determine that the reply message corresponding to the question message needs to be determined by using the question-answering model 290 at the server device 120. That is, the policy module 210 may determine the question-answering model 242 as the target question-answering model, and may also determine the question-answering model 290 as the target question-answering model. The first capability level and the second capability level here may be the same capability level or different capability levels, and both of them may be any appropriate network capability level configured according to actual needs.

In some embodiments, in the case that it is determined that there is currently network communication or the current network communication is good, the policy module 210 may preferentially select the question-answering model 290 by default, or may further determine the target question-answering model in combination with the complexity 312 of the question message. In this way, whether there is currently network communication or whether the network communication is good, the policy module 210 may determine the reply message by using a question-answering model, which may enrich the application scenarios of the answering service and help to improve the answering experience of the user.

For example, the client device 110 may provide the received question message to the local question-answering model 242 in response to the local question-answering model 242 being determined as the target question-answering model. The question-answering model 242 may determine a reply message 333 for the question message based on a predetermined number of historical messages stored locally or accessible by the client device 110 and the question message received this time.

In some embodiments, the predetermined number may be determined based on the amount of historical context information required by the question-answering model 242. As an example, if the question-answering model 242 needs 10 historical messages, the client device 110 may send 10 historical messages and the question message to the question-answering model 242, and obtain the reply message for the question message from the question-answering model 242.

In some embodiments, the predetermined number may also be determined based on a model input requirement of the question-answering model 242. As an example, if the model input requirement of the question-answering model 242 indicates that the model input includes at most 10 messages, the client device 110 may determine that 9 historical messages may be sent to the question-answering model 242 together with the question message. In this way, the client device 110 may provide 10 messages in total to the question-answering model 242.

The question-answering chat to which the question message belongs may include one or more historical messages, and the one or more historical messages may be stored in the message storage module 330. Each of the one or more historical messages may include a historical question message or a historical reply message in the question-answering chat . The one or more historical messages may include historical messages that have been synchronized to the server device 120, and may also include a set of historical messages 331 that have not been synchronized to the server device 120. It should be understood that the historical messages that have been synchronized to the server device 120 should be historical messages before the set of historical messages 331 that have not been synchronized. It should be understood that each historical reply message in the set of historical messages 331 that have not been synchronized is generated by the local question-answering model 242 based on a corresponding historical question message.

It should be understood that the one or more historical messages may also include only the set of historical messages 331 or the historical messages that have been synchronized to the server device 120. The predetermined number of historical messages provided by the client device 110 to the question-answering model 242 may be a predetermined number of the most recent messages in the one or more historical messages, may be a predetermined number of messages with the highest degree of association with the question message in the one or more historical messages, and may also be a predetermined number of messages randomly determined from the one or more historical messages.

For example, the client device 110 may further determine (320) whether there is a set of historical messages 331 in the question-answering chat to which the question message belongs that have not been synchronized to the server device 120 in response to the question-answering model 290 being determined as the target question-answering model. The client device 110 may send the question message and at least one of the set of historical messages 331 to the server device 120 in response to the presence of the set of historical messages 331. The at least one historical message includes at most a predetermined number of the most recent historical messages in the set of historical messages 331.

It should be understood that if the number of messages included in the set of historical messages 331 exceeds the predetermined number, the client device 110 may send at most the predetermined number of historical messages together with the question message. If the number of messages included in the set of historical messages 331 does not reach the predetermined number, the client device 110 may send the entire set of historical messages 331 together with the question message to the server device 120. In some embodiments, the predetermined number may be determined based on the amount of historical context information required by the question-answering model 290 at the server device 120. In some embodiments, the predetermined number may also be determined based on a model input requirement of the question-answering model 290. The predetermined number for the question-answering model 290 and the predetermined number for the question-answering model 242 mentioned above may be the same number or different numbers, which is not limited in the present disclosure.

The server device 120 may determine, using the question-answering model 290 at the server device 120, a reply message 335 for the question message based on the question message and the at least one historical message in response to receiving the question message and the at least one historical message that has not been previously synchronized to the server device 120. The server device 120 may send the reply message 335 to the server device 120 in response to determining the reply message 335.

In this way, while providing the question message to the question-answering model 290 at the server device 120, at least one of the set of historical messages 331 that have not been synchronized may also be provided to the server device 120, which may implement information synchronization between the client device 110 and the server device 120, ensure that the server device 120 may also have sufficient historical context, and help to improve the accuracy of answers.

In some embodiments, in order to ensure that the order of messages synchronized at the client device 110 and the server device 120 in the same question-answering chat remains consistent, the client device 110 may assign a client identification to a message in the question-answering chat, and the server device 120 may assign a server identification to a message that has been synchronized. Both the client identification and the server identification may be any appropriate identification such as a numeric value and a character string. In the following, only the case that both the client identification and the server identification are numeric values is taken as an example for description. The client device 110 may provide the client identification of the message together with the message to the server device 120, and the server device 120 may also send the server identification of the message to the client device 110.

It should be understood that each of the one or more historical messages may have a client identification assigned by the client device 110. Each historical message in the one or more historical messages that has been synchronized to the server device 120 has a server identification assigned by the server device 120 and a client identification assigned by the client device 110. The set of historical messages 331 that have not been synchronized to the server device 120 may only have a set of client identifications 332 assigned by the client device 110.

Regarding the manner of assigning the set of client identifications 332 corresponding to the set of historical messages 331, the client device 110 may assign a client identification corresponding to each historical message in the set of historical messages 33 based on a client identification corresponding to a historical message that has been synchronized to the server device 120 and that is before the set of historical messages 331. As an example, if the client identification of the historical message preceding the set of historical messages 331 is A, the client device 110 may assign a client identification "A+1" to the first historical message in the set of historical messages 331, assign a client identification "A+2" to the second historical message, and so on, and the client identifications of each of the historical messages in the set of historical messages 331 may be increased sequentially based on the order of the set of historical messages 331. The order of the set of historical messages 331 may be based on time information corresponding to each of the set of historical messages. The time information corresponding to the historical message may be time information when the client device 110 receives the historical message.

In some embodiments, in response to determining the reply message 333 using the question-answering model 242, the client device 110 may further use an identification generation policy 340 to assign corresponding client identifications to the question message and the reply message 333 determined by the question-answering model 242, respectively. For example, the client device 110 may determine a client identification of the question message based on a client identification of a historical message (for example, the last historical message in the set of historical messages 331) before the question message, and may determine the client identification 334 of the reply message 333 based on the client identification of the question message. The question message, the client identification of the question message, the reply message 333, and the client identification 334 of the reply message 333 may all be stored in the message storage module 330 at the client device 110.

In some embodiments, in response to determining that the reply message is to be determined using the question-answering model 292, the client device 110 may further send, to the server device 120, a client identification (that is, the set of client identifications 332) corresponding to each historical message in the set of historical messages 331 in association with the question message and the at least one historical message. In this case, the server device 120 may receive the set of client identifications 332 corresponding to the set of historical messages 331 in association with the question message and the at least one historical message. For example, the server device 120 may determine, based on the set of client identifications 332, the number of historical messages included in the set of historical messages 331 (that is, the number of messages in the set of historical messages 331).

In some embodiments, the server device 120 may use an identification generation policy 350 to assign a server identification to the question message in response to receiving the question message. Specifically, for example, the server device 120 may determine, based on the set of client identifications 332, the number of historical messages included in the set of historical messages 331 (that is, the number of messages in the set of historical messages 331). For example, the server device 120 may assign the server identification to the question message based on the number of messages in the set of historical messages 331 and a server identification corresponding to a message that has been synchronized to the server device 120 and that is before the set of historical messages 331 according to the identification generation policy 350. For example, if the number of messages in the set of historical messages 331 is 10, and the server identification of the the most recent message in the messages that have been synchronized to the server device 120 is B, the server device 120 may determine that the server identification of the question message is B+10+1. In this way, the server device 120 may reserve a location for the server identification for the set of historical messages 331, so as to avoid subsequent assignment of the same server identification to the historical messages in the set of historical messages and the question message.

For example, the server device 120 may send, to the client device 110, feedback for the question message, where the feedback may include at least the server identification corresponding to the question message. The server device 120 may send the feedback for the question message to the client device 110 before sending the reply message 335, or may send the feedback for the question message to the client device 110 together with the reply message 335 (that is, the client device 110 may receive the feedback first and then receive the reply message 335, or may receive the feedback and the reply message 335 at the same time). The present disclosure does not limit the timing of sending the feedback for the question message.

In some embodiments, the server device 120 may further determine a server identification 336 corresponding to the reply message 335 based on the server identification corresponding to the question message. As an example, if the server identification corresponding to the question message is C, the server device 120 may assign a server identification "C+1" to the reply message 335. In some embodiments, for the server device 120 of the message that has been synchronized to the server device 120, the server identifications may be increased sequentially based on the order of the messages, the order of the messages may be based on time information of the messages, and the time information corresponding to the messages may be time information when the server device 120 receives the messages. In some embodiments, each message that has been synchronized to the server device 120 may have a unique server identification, that is, different messages correspond to different server identifications.

For example, the server device 120 may further send the server identification 336 of the reply message to the client device 110. It should be understood that the server device 120 may also send the server identification 336 to the client device 110 at any appropriate timing, for example, the server device 120 may send the server identification 336 to the client device 110 together with the reply message 335, or may send the reply message 335 to the client device 110 first and then send the server identification 336 to the client device 110.

In some embodiments, in response to receiving the reply message 335 and the server identification 336 of the reply message 335, the client device 110 may use the identification generation policy 340 to assign a client identification 337 of the reply message 335 based on the server identification 336. As an example, if the identification generation policy 340 indicates that the client identification of the received message is k times the server identification of the message (k may be any value greater than 1, etc.) or is increased by a value on the basis of the server identification. If the server identification 336 is a value D, the client device 110 may determine that the client identification 337 of the reply message 335 is k*D.

In some embodiments, if the question message is a question text, and the reply message provided to the user is also an reply text, the reply message may be determined directly via the method shown in the above example 300, and the reply message may be provided to the user. For example, the client device 110 may present the reply text in an interaction interface between the user and a digital assistant. In some embodiments, if the question message is a question voice, the client device 110 also needs to use an ASR model and a TTS model to provide a voice service. Specifically, still referring to FIG. 2, in some embodiments, in the case that the question message includes the question voice, the policy module 210 may determine an ASR distribution policy based on the network communication capability (for example, it may also be based on a user requirement specifying a machine learning model to perform the ASR function, a version and a source of the machine learning model, etc.), and select a corresponding ASR model to perform the ASR function on the question voice based on the determined ASR distribution policy.

In some embodiments, the policy module 210 may determine that the ASR function needs to be performed by using a machine learning model local to the client device 110 in response to determining that there is currently no network communication or that the current network communication is poor. In this case, the policy module 210 selects the local ASR model 241 to perform the ASR function on the question voice (this case may also be referred to as an offline ASR function). The policy module 210 may instruct the offline call module 230 to perform the ASR function on the question voice by using the ASR model 241 in the local model capability 240. The offline call module 230 may provide the question voice to the ASR model 241, and obtain a model output of the ASR model 241 for this question voice, where the model output may indicate an ASR text (which may also be referred to as an offline ASR text) for the question voice. The client device 110 may determine the received offline ASR text as the question text for the question voice. The question text determined via the ASR model 241 may be referred to as an offline question text.

In some embodiments, the policy module 210 may select the ASR model 241 and/or the ASR model 281 to perform the ASR function on the question voice in response to determining that there is currently network communication or the current network communication is good. In this case, the policy module 210 may instruct the offline call module 230 to perform the offline ASR function on the question voice by using the ASR model 241 in the local model capability 240, and/or may instruct the online request module 220 to send the question voice to the server device 120 to request to perform the ASR function on the question voice by using the ASR model 281 (this case may also be referred to as an online ASR function).

Regarding the specific manner of sending the question voice to the server device 120, in some embodiments, a network connection may be established between the client device 110 and the server device 120, and the network connection may be a long connection that conforms to the transmission control protocol (TCP). For example, the client device 110 may establish a long connection with the network interface 255 of the access layer 250 of the server device 120 through a three-way interaction process (which may also be referred to as three-way handshake) specified by the TCP protocol. The server device 120 may receive the question voice via the network interface 255, and provide the question voice to the voice module 260. The voice module 260 may provide the question voice to the ASR model 281 at the voice service 280, and obtain a model output of the ASR model 281 for this question voice, where the model output may indicate an ASR text (which may also be referred to as an online ASR text) for the question voice.

After determining the question text of the question voice, the policy module 210 may determine a question-answering policy for the question text, and determine a corresponding reply text based on the question text according to the question-answering policy. It has been described above that the client device 110 may determine at least one of the complexity 312 of the question message and the network communication capability 314 between the client device 110 and the server device 120, and determine the question-answering policy based on the determination result, which will not be repeated here.

If the question-answering model 242 is determined as the target question-answering model, the policy module 210 may instruct the offline call module 230 to determine a corresponding reply text based on the question text by using the question-answering model 242. The offline call module 230 may provide the question text to the question-answering model 242, and obtain a model output of the question-answering model 242 for this question text, where the model output may indicate an reply text (which may also be referred to as an offline reply text) for the question text.

If the question-answering model 290 is determined as the target question-answering model, the policy module 210 may instruct the online request module 220 to send the question text to the server device 120 to request to determine a corresponding reply text based on the question text by using the question-answering model 290. The server device 120 may receive the question text via the network interface 255, and provide the question text to the question-answering module 270. The question-answering module 270 may provide the question text to the question-answering model 290, and obtain a model output of the question-answering model 290 for this question text, where the model output may indicate an reply text (which may also be referred to as an online reply text) for the question text.

It should be noted that, in some embodiments, in order to improve the efficiency of determining the online reply text, in the case that the question text is determined using the ASR model 281 at the server device 120, the voice module 260 may also directly provide the online ASR text to the question-answering module 270 to instruct the question-answering module 270 to determine the corresponding online reply text in response to obtaining the online ASR text.

The question-answering module 270 may send the reply text to the network interface 255 of the access layer 250 (this process may also be referred to as the question-answering module 270 returning the reply text to the network interface 255). The access layer 250 may send the obtained reply text to the online request module 220 of the client device 110. The policy module 210 may determine a TTS distribution policy for the reply text in response to the client device 110 obtaining the reply text (that is, obtaining the online reply text or the offline reply text), and select a corresponding TTS model to perform the TTS function on the reply text according to the determined TTS distribution policy.

For example, the policy module 210 may determine the TTS distribution policy for the reply text based on at least one of a speech conversion requirement of the reply text and the network communication capability. The policy module 210 may determine the speech conversion requirement of the reply text in any appropriate manner. For example, the policy module 210 may determine the speech conversion requirement of the reply text based on a predetermined rule or algorithm. For example, the policy module 210 may determine the corresponding speech conversion requirement based on the number of text units included in the reply text, at least one keyword included in the reply text, and so on. For another example, the policy module 210 may also determine the speech conversion requirement of the reply text by using a trained machine learning model.

The speech conversion requirement may indicate one or more of an intonation requirement for the reply text, a speech timbre requirement for the reply text, a speech quality requirement for the reply text, etc. As an example, the model size of the TTS model 282 at the server device 120 is larger than the model size of the TTS model 243 local to the client device 110, and compared with the TTS model 243, the TTS model 282 may generate more natural intonation (that is, more anthropomorphic) speech, higher quality speech, or provide more timbre choices. For example, if the speech conversion requirement of the reply text indicates to generate speech with natural intonation and specific timbre, the policy module 210 may determine, based on the speech conversion requirement, that the TTS function needs to be performed by using the TTS model 282 at the server device 120 (this case may also be referred to as an online TTS function). If the speech conversion requirement of the reply text indicates a relatively low requirement for speech quality, the policy module 210 may call the local TTS model 243 to perform the TTS function (this case may also be referred to as an offline TTS function). The specific manner of determining the TTS policy based on the network communication capability will not be repeated here.

In some embodiments, if it is determined based on the TTS distribution policy that the TTS model 243 is to be selected, the policy module 210 may instruct the offline call module 230 to perform the offline TTS function on the reply text by using the TTS model 243 in the local model capability 240. For example, the offline call module 230 may provide the reply text to the TTS model 243 in response to receiving the instruction from the policy module 210, and obtain a model output of the TTS model 243 for this reply text, where the model output may indicate TTS speech (which may also be referred to as offline TTS speech) for the reply text. The client device 110 may determine the received offline TTS speech as the answer voice for the reply text. The answer voice determined via the TTS model 243 may be referred to as an offline answer voice.

In some embodiments, if it is determined based on the TTS distribution policy that the TTS model 282 is to be selected, the policy module 210 may instruct the online request module 220 to send the reply text to the server device 120 to request to perform the online TTS function on the reply text by using the TTS model 282. The server device 120 may receive the reply text via the network interface 255, and provide the reply text to the voice module 260. The voice module 260 may provide the reply text to the TTS model 282 at the voice service 280, and obtain a model output of the TTS model 282 for this reply text, where the model output may indicate TTS speech (which may also be referred to as online TTS speech) for the reply text. The client device 110 may determine the received online TTS speech as the answer voice for the reply text. The answer voice determined via the TTS model 282 may be referred to as an online answer voice.

The client device 110 may provide the answer voice to the user in response to obtaining the answer voice (the offline answer voice and/or the online answer voice). For example, the client device 110 may play the answer voice in the interaction interface between the user and the digital assistant. The client device 110 may play the answer voice to the user via a speaker.

In some embodiments, the client device 110 may further send, to the server device 120, a group of historical messages that have not been synchronized to the server device 120, or other historical messages other than at least one historical message (that is, the historical message sent to the server device 120 together with the question message) in the group of historical messages, and the client identification corresponding to each historical message, when the communication between the client device 110 and the server device 120 is in an idle state.

The server device 120 may receive, from the client device 110, the set of historical messages or other historical messages in the set of historical messages than the at least one historical message and the client identification corresponding to each historical message in response to the communication between the client device 110 and the server device 120 being in the idle state. The server device 120 may determine the order of each historical message in the set of historical messages based on the client identification corresponding to each historical message in the set of historical messages, and assign a server identification corresponding to each historical message to the set of historical messages based on the order. For example, the server identifications of each of the set of historical messages may be increased sequentially based on the order. For example, if the server identification of the last historical message previously synchronized is 1, the server identification of the first historical message in the set of historical messages may be 2, the server identification of the second historical message may be 3, and so on.

For example, the server device 120 may assign the server identification corresponding to each historical message to the set of historical messages based on a server identification corresponding to a historical message preceding the set of historical messages. The server device 120 may send the server identification corresponding to each historical message in the set of historical messages to the client device 110. The client device 110 may receive the server identification corresponding to each historical message in the set of historical messages from the server device 120. For example, the client device 110 may update the set of historical messages, and the updated set of historical messages has the server identification assigned by the server device 120 and the client identification assigned by the client device 110.

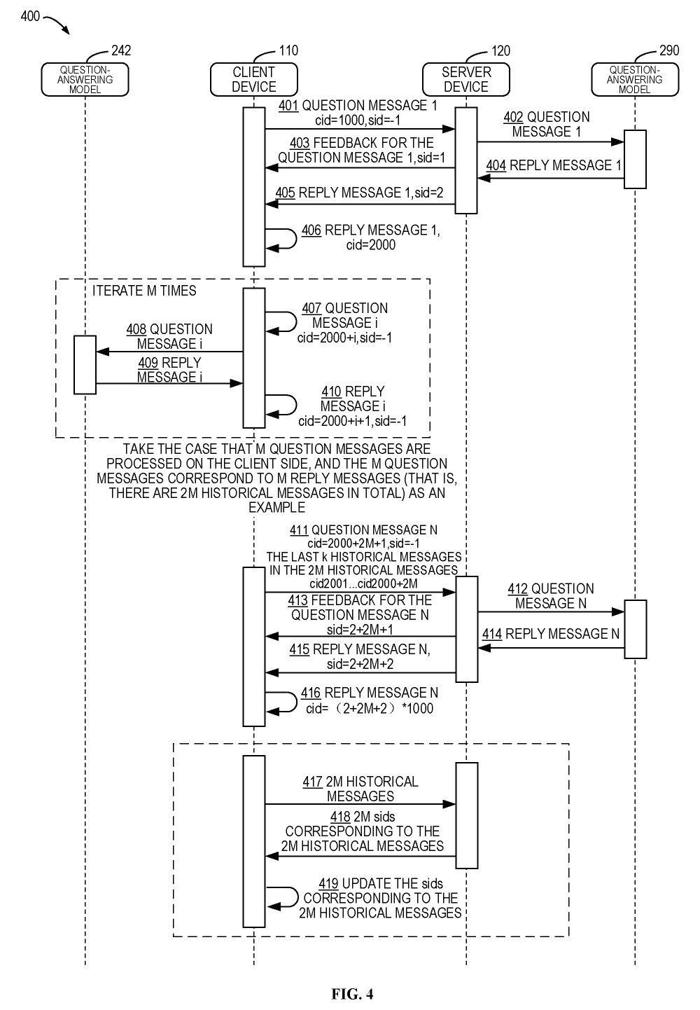

As an example, reference is made to FIG. 4, which shows a schematic diagram of a signaling flow 400 for information processing according to some embodiments of the present disclosure. For the convenience of discussion, the signaling flow 400 will be described with reference to FIG. 1. As shown in FIG. 4, the signaling flow 400 involves the client device 110, the question-answering model 242 at the client device 110, the server device 120, and the question-answering model 290 at the server device 120. In the example 400, the case that question messages are in one-to-one correspondence to reply messages (that is, each question message corresponds to one reply message) is taken as an example for description. The client identification may be represented by cid, and the server identification may be represented by sid.

As shown in FIG. 4, the client device 110 may send (401), to the server device 120, a question message 1 received in a question-answering chat and a client identification of the question message 1 (for example, cid=1000) in response to determining the question-answering model 290 as the target question-answering model. In some embodiments, in the case that the message does not have a server identification assigned by the server device 120, the client device 110 may set the server identification of the message to a default value (for example, sid=-1 in the figure). In this case, the client device 110 may send the question message1, the client identification of the question message 1, and a default server identification of the question message 1 to the server device 120.

The server device 120 may send (403), to the client device 110, feedback for the question message 1 in response to receiving the question message 1, where the feedback may include a server identification (for example, sid=1) assigned by the server device 120 to the question message 1. The server device 120 may further provide (402) the question message 1 to the question-answering model 290, and obtain (404) a model output for the question message 1 from the question-answering model 290, where the model output may indicate a reply message 1 for the question message 1. The server device 120 may send the feedback to the client device 110 first and then provide the question message 1 to the question-answering model 290, may provide the question message 1 to the question-answering model 290 while sending the feedback to the client device 110, or may provide the question message 1 to the question-answering model 290 first and then send the feedback to the client device 110, which is not limited in the present disclosure.

The server device 120 may determine a server identification (for example, sid=2) of the reply message 1 by using an identification generation policy at the server device 120, and the server device 120 may send (405) the reply message 1 and the server identification of the reply message 1 together to the client device 110. The client device 110 may determine (406) a client identification of the reply message 1 by using an identification generation policy at the client device 110 in response to receiving the reply message 1 and the server identification of the reply message 1. For example, if the identification generation policy at the client device 110 indicates that the client identification of the reply message is 1000 times the server identification, the client device 110 may determine that the client identification of the reply message 1 is cid=2000.

In this way, after switching from determining the reply message by using the question-answering model 290 to determining the reply message by using the question-answering model 242, the client identification of the message determined by the local question-answering model 242 is determined based on the client identification of the synchronized message, and the client identification is set to be relatively large, which may leave a relatively large space for the client identification of the message determined by the question-answering model 242, and help to ensure the uniqueness of the client identifications corresponding to different messages. It may avoid the case that the client identification determined based on the server device 120 is repeated with the client identification determined directly locally (that is, the client identification assigned to the reply message determined locally). It should be understood that the identification generation policy here is only an example, and there may be any appropriate calculation relationship between the actual client identification and the server identification, for example, the client identification may be any appropriate multiple of the server identification, such as 20 times and 100 times, the client identification may also be the server identification+1000, the server identification+100, etc., which is not limited in the present disclosure.

If the client device 110 subsequently determines the question-answering model 242 as the target question-answering model, the client device 110 may use the question-answering model 242 to determine the reply message of the received question message. Taking the case that M question messages are processed on the client device 110 side as an example, for the i-th question message (the i-th question message may be any question message in the M question messages) in the M question messages, the client device 110 may determine, using the identification generation policy at the client device 110, that a client identification of the question message i is cid=2000+i in response to receiving (407) the question message i. Since the question message i has not been synchronized to the server device 120, the client device 110 may determine the server identification of the question message i as a default value sid= -1.

The client device 110 may provide (408) the question message i to the question-answering model 242, and obtain (409) a model output for the question message i from the question-answering model 242, where the model output may indicate a reply message i for the question message i. The client device 110 may use the identification generation policy at the client device 110 to determine (410) that a client identification of the reply message i is cid=2000+i+1. Since the reply message i has not been synchronized to the server device 120, the client device 110 may determine the server identification of the reply message i as the default value sid= -1.

The client device 110 may send, to the server device 120, k historical messages in 2M historical messages (that is, M historical question messages and corresponding M historical reply messages) before the question message N together with the question message N in response to receiving the question message N and determining the question-answering model 290 as the target question-answering model again (that is, the newly received question message N is to be processed using the question-answering model 290). The k historical messages may be the k messages with the latest corresponding time in the 2M historical messages (that is, the last k historical messages in the 2M historical messages), the k messages with the earliest corresponding time in the 2M historical messages (that is, the first k historical messages in the 2M historical messages), any k messages in the 2M historical messages, any k messages in the 2M historical messages that have the highest correlation with the question message N, and so on.

The client device 110 may further send (411), to the server device 120, the k historical messages before the question message N, the question message N, the respective client identifications (that is, cid2001 to cid2000+2M in the figure) of the 2M historical messages, the client identification (for example, cid2000+2M+1) of the question message N, and the default server identification (that is, sid=-1) of the question message N together. The server device 120 may send (413), to the client device 110, feedback for the question message N in response to receiving the question message N, where the feedback may include a server identification (for example, sid=2+2M+1) assigned by the server device 120 to the question message N. The server device 120 may further provide (412) the question message N to the question-answering model 290, and obtain (414) a model output for the question message N from the question-answering model 290, where the model output may indicate a reply message N for the question message N.

The server device 120 may determine a server identification (for example, sid=2+2M+2) of the reply message N by using the identification generation policy at the server device 120, and the server device 120 may send (415) the reply message N and the server identification of the reply message N together to the client device 110. The client device 110 may determine (416) a client identification (for example, cid=(2+2M+2)*1000) of the reply message N by using the identification generation policy at the client device 110 in response to receiving the reply message N and the server identification of the reply message N.

The client device 110 may send the 2M historical messages to the server device 120 in a subsequent idle state (for example, before the next question message is received). In some embodiments, the client device 110 may also send other historical messages (that is, 2M-k historical messages) other than the k historical messages in the 2M historical messages to the server device. The client device 110 may send the 2M historical messages/2M-k historical messages and the respective client identifications of the 2M historical messages together to the server device 120. The server device 120 may assign 2M corresponding server identifications to the 2M historical messages based on the identification generation policy at the server device 120.

The client device 110 may then update the server identifications corresponding to the 2M historical messages in response to obtaining the respective server identifications of the 2M historical messages. For example, the client device 110 may update the respective server identifications of the 2M historical messages from the default sid=-1 to the newly obtained server identifications.

To sum up, when it is necessary to use the model at the server device to process a question, the client device takes the initiative to send at least part of historical messages that have not been synchronized locally to the server device. This may ensure that, in the case that the information between the client device and the server device is not fully synchronized, the model at the server device also has sufficient and correct conversation historical context to process the current question, thereby giving a correct answer. This may implement information synchronization between the client device and the server device, so that both the question-answering model local to the client device and the question-answering model at the server device may determine answers based on the same historical information, which facilitates the improvement of the accuracy of answers. In addition, in order to ensure the efficiency of current question-answering, in the case that there are a relatively large number of historical messages that have not been synchronized locally on the client device, it is not necessary to upload all the historical messages that have not been synchronized at once, but the latest part of historical messages that are more concerned in the model processing are selected and uploaded.

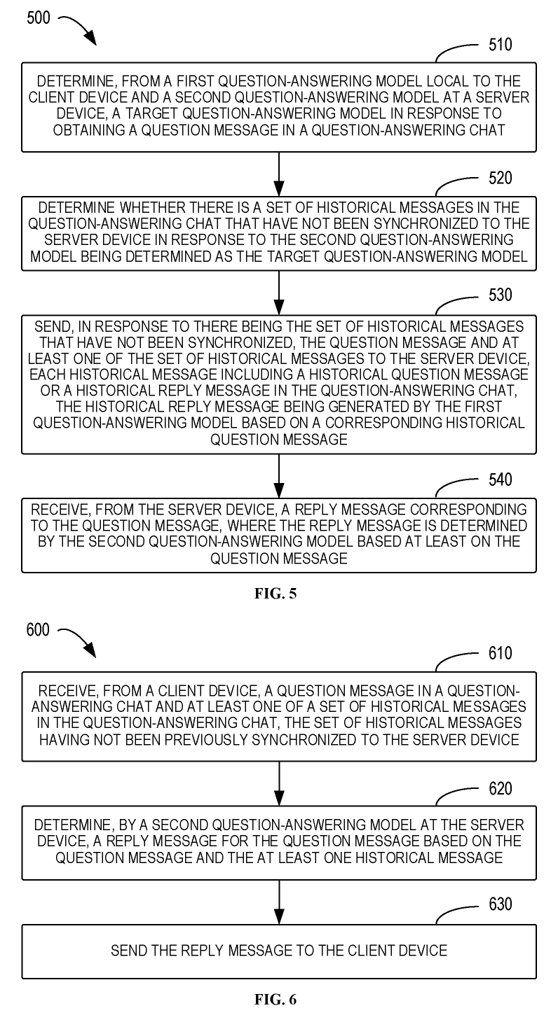

FIG. 5 shows a flowchart of a method 500 for information processing implemented at the client device 110 according to some embodiments of the present disclosure.

At block 510, the client device 110 determines, from a first question-answering model local to the client device and a second question-answering model at a server device, a target question-answering model in response to obtaining a question message in a question-answering chat.

At block 520, the client device 110 determines whether there is a set of historical messages in the question-answering chat that have not been synchronized to the server device in response to the second question-answering model being determined as the target question-answering model.

At block 530, the client device 110 sends, in response to there being the set of historical messages that have not been synchronized, the question message and at least one of the set of historical messages to the server device, each historical message including a historical question message or a historical reply message in the question-answering chat, the historical reply message being generated by the first question-answering model based on a corresponding historical question message.

At block 540, the client device 110 receives, from the server device, a reply message corresponding to the question message, where the reply message is determined by the second question-answering model based at least on the question message.

In some embodiments, the method 500 further includes: sending, to the server device, a client identification corresponding to each historical message in the set of historical messages in association with the question message and the at least one historical message.

In some embodiments, a message that has been synchronized to the server device has a server identification assigned by the server device and a client identification assigned by the client device.

In some embodiments, the client identification corresponding to each historical message in the set of historical messages is assigned based on the following: assigning, based on a client identification corresponding to a historical message preceding the set of historical messages, the client identification corresponding to each historical message in the set of historical messages, where the historical message preceding the set of historical messages has been synchronized to the server device.

In some embodiments, a client identification assigned to the question message by the client device is sent to the server device together with the question message, and the method 500 further includes: receiving, from the server device, feedback for the question message, the feedback including at least a server identification corresponding to the question message.

In some embodiments, the method 500 further includes: receiving, from the server device, a server identification assigned to the reply message in association with the reply message; and assigning, using an identification generation policy, a client identification of the reply message based on the server identification of the reply message.

In some embodiments, the at least one historical message includes at most a predetermined number of the most recent historical messages in the set of historical messages.

In some embodiments, the predetermined number is determined based on an amount of historical context information required by the second question-answering model.

In some embodiments, the method 500 further includes: sending, to the server device and in response to a communication between the client device and the server device being in an idle state, the set of historical messages or other historical messages in the set of historical messages than the at least one historical message, and a client identification corresponding to each historical message; and receiving, from the server device, a server identification corresponding to each historical message in the set of historical messages.

In some embodiments, determining, from a first question-answering model local to the client device and a second question-answering model at a server device, a target question-answering model includes: determining, from the first question-answering model and the second question-answering model, the target question-answering model based on at least one of: a complexity of the question message, or a network communication capability between the client device and the server device.

FIG. 6 shows a flowchart of a method 600 for information processing implemented at the server device 120 according to some embodiments of the present disclosure.

At block 610, the server device 120 receives, from a client device, a question message in a question-answering chat and at least one of a set of historical messages in the question-answering chat, the set of historical messages having not been previously synchronized to the server device.

At block 620, the server device 120 determines, by a second question-answering model at the server device, a reply message for the question message based on the question message and the at least one historical message.

At block 630, the server device 120 sends the reply message to the client device.

In some embodiments, the method 600 further includes: receiving, from the client device, a client identification corresponding to each historical message in the set of historical messages in association with the question message and the at least one historical message.

In some embodiments, the method 600 further includes: determining, in response to receiving the question message, a number of messages in the set of historical messages based on the client identification corresponding to each historical message in the set of historical messages; assigning a server identification to the question message based on the number of messages and a server identification corresponding to a message that has been synchronized to the server device and that precedes the set of historical messages; and sending, to the client device, feedback for the question message, the feedback including at least the server identification corresponding to the question message.

In some embodiments, the method 600 further includes: receiving, from the client device and in response to a communication between the client device and the server device being in an idle state, the set of historical messages or other historical messages in the set of historical messages than the at least one historical message and the client identification corresponding to each historical message; determining an order of each historical message in the set of historical messages based on the client identification corresponding to each historical message in the set of historical messages; assigning a server identification corresponding to each historical message to the set of historical messages based on the order; and sending, to the client device, the server identification corresponding to each historical message in the set of historical messages.

In some embodiments, assigning a server identification corresponding to each historical message to the set of historical messages includes: assigning, based on a server identification corresponding to a historical message preceding the set of historical messages, the server identification corresponding to each historical message to the set of historical messages.

Embodiments of the present disclosure further provide corresponding apparatuses for implementing the above methods or processes. FIG. 7 shows an example structural block diagram of an apparatus 700 for information processing implemented at the client device 110 according to some embodiments of the present disclosure. Each module/component in the apparatus 700 may be implemented by hardware, software, firmware, or any combination thereof.

As shown in FIG. 7, the apparatus 700 includes a question-answering model determination module 710 configured to determine, from a first question-answering model local to the client device and a second question-answering model at a server device, a target question-answering model in response to obtaining a question message in a question-answering chat . The apparatus 700 further includes a historical message determination module 720 configured to determine whether there is a set of historical messages in the question-answering chat that have not been synchronized to the server device in response to the second question-answering model being determined as the target question-answering model. The apparatus 700 further includes a question message sending module 730 configured to send, in response to there being the set of historical messages that have not been synchronized, the question message and at least one of the set of historical messages to the server device, each historical message including a historical question message or a historical reply message in the question-answering chat, the historical reply message being generated by the first question-answering model based on a corresponding historical question message. The apparatus 700 further includes a reply message receiving module 740 configured to receive, from the server device, a reply message corresponding to the question message, where the reply message is determined by the second question-answering model based at least on the question message.

In some embodiments, the apparatus 700 further includes: a client identification sending module configured to send, to the server device, a client identification corresponding to each historical message in the set of historical messages in association with the question message and the at least one historical message.

In some embodiments, a message that has been synchronized to the server device has a server identification assigned by the server device and a client identification assigned by the client device.

In some embodiments, the client identification corresponding to each historical message in the set of historical messages is assigned based on the following: assigning, based on a client identification corresponding to a historical message preceding the set of historical messages, the client identification corresponding to each historical message in the set of historical messages, where the historical message preceding the set of historical messages has been synchronized to the server device.

In some embodiments, a client identification assigned to the question message by the client device is sent to the server device together with the question message, and the apparatus 700 further includes: feedback receiving module configured to receive, from the server device, feedback for the question message, the feedback including at least a server identification corresponding to the question message.

In some embodiments, the apparatus 700 further includes: a server identification receiving module configured to receive, from the server device, a server identification assigned to the reply message in association with the reply message; and a client identification assignment module configured to assign, using an identification generation policy, a client identification of the reply message based on the server identification of the reply message.

In some embodiments, the at least one historical message includes at most a predetermined number of the most recent historical messages in the set of historical messages.

In some embodiments, the predetermined number is determined based on an amount of historical context information required by the second question-answering model.

In some embodiments, the apparatus 700 further includes: a historical message sending module configured to send, to the server device and in response to a communication between the client device and the server device being in an idle state, the set of historical messages or other historical messages in the set of historical messages than the at least one historical message, and a client identification corresponding to each historical message; and a historical server identification receiving module configured to receive, from the server device, a server identification corresponding to each historical message in the set of historical messages.

In some embodiments, the question-answering model determination module 710 is further configured to determine, from the first question-answering model and the second question-answering model, the target question-answering model based on at least one of: a complexity of the question message, or a network communication capability between the client device and the server device.

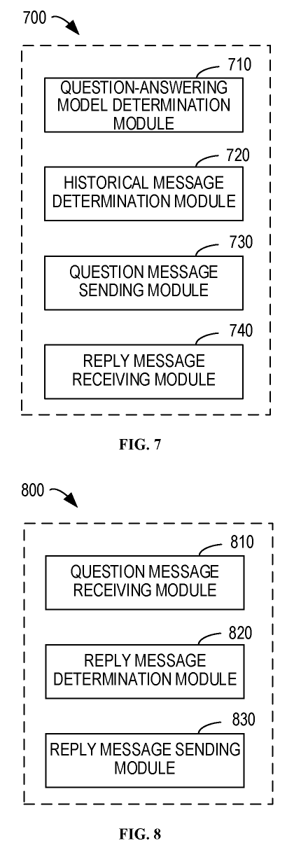

FIG. 8 shows an example structural block diagram of an apparatus 800 for information processing implemented at the server device 120 according to some embodiments of the present disclosure. Each module/component in the apparatus 800 may be implemented by hardware, software, firmware, or any combination thereof.

As shown in FIG. 8, the apparatus 800 includes a question message receiving module 810 configured to receive, from a client device, a question message in a question-answering chat and at least one of a set of historical messages in the question-answering chat, the set of historical messages having not been previously synchronized to the server device. The apparatus 800 further includes a reply message determination module 820 configured to determine, by a second question-answering model at the server device, a reply message for the question message based on the question message and the at least one historical message. The apparatus 800 further includes a reply message sending module 830 configured to send the reply message to the client device.

In some embodiments, the apparatus 800 further includes: a client identification receiving module configured to receive, from the client device, a client identification corresponding to each historical message in the set of historical messages in association with the question message and the at least one historical message.

In some embodiments, the apparatus 800 further includes: a number determination module configured to determine, in response to receiving the question message, a number of messages in the set of historical messages based on the client identification corresponding to each historical message in the set of historical messages; a server identification assignment module configured to assign a server identification to the question message based on the number of messages and a server identification corresponding to a message that has been synchronized to the server device and that precedes the set of historical messages; and feedback sending module configured to send, to the client device, feedback for the question message, the feedback including at least the server identification corresponding to the question message.

In some embodiments, the apparatus 800 further includes: a historical message receiving module configured to receive, from the client device and in response to a communication between the client device and the server device being in an idle state, the set of historical messages or other historical messages in the set of historical messages than the at least one historical message and the client identification corresponding to each historical message; an order determination module configured to determine an order of each historical message in the set of historical messages based on the client identification corresponding to each historical message in the set of historical messages; a historical server identification assignment module configured to assign a server identification corresponding to each historical message to the set of historical messages based on the order; and a historical server identification sending module configured to send, to the client device, the server identification corresponding to each historical message in the set of historical messages.

In some embodiments, the historical server identification assignment module is further configured to assign, based on a server identification corresponding to a historical message preceding the set of historical messages, the server identification corresponding to each historical message to the set of historical messages.

The modules included in the apparatus 700 and/or the apparatus 800 may be implemented in various ways, including software, hardware, firmware, or any combination thereof. In some embodiments, one or more modules may be implemented using software and/or firmware, such as machine-executable instructions stored on a storage medium. In addition to machine-executable instructions or as an alternative, some or all modules in the apparatus 700 and/or the apparatus 800 may be implemented at least partially by one or more hardware logic components. As an example, rather than a limitation, example types of hardware logic components that may be used include a field programmable gate array (FPGA), an application specific integrated circuit (ASIC), an application specific standard (ASSP), a system on chip (SOC), a complex programmable logical device (CPLD), and so on.

It should be understood that one or more steps in the above methods may be performed by an appropriate electronic device or a combination of electronic devices. Such an electronic device or a combination of electronic devices may include, for example, the client device 110 and the server device 120 in FIG. 1.

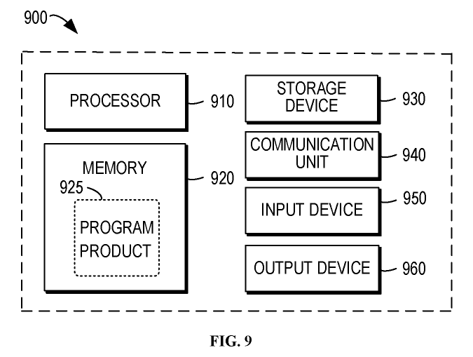

FIG. 9 shows a block diagram of an electronic device 900 in which one or more embodiments of the present disclosure may be implemented. It should be understood that the electronic device 900 shown in FIG. 9 is only illustrative, and should not constitute any limitation on the functions and scope of the embodiments described herein. The electronic device 900 shown in FIG. 9 may be used to implement the client device 110 or the server device 120 in FIG. 1.

As shown in FIG. 9, the electronic device 900 is in the form of a general electronic device. The components of the electronic device 900 may include, but are not limited to, one or more processing units or processors 910, a memory 920, a storage device 930, one or more communication units 940, one or more input devices 950, and one or more output devices 960. The processor 910 may be an actual or virtual processor, and may perform various processing based on a program stored in the memory 920. In a multi-processor system, multiple processors execute computer-executable instructions in parallel to improve the parallel processing capability of the electronic device 900.

The electronic device 900 typically includes multiple computer storage medium. Such medium may be any available medium that is accessible to the electronic device 900, including but not limited to volatile and non-volatile medium, removable and non-removable medium. The memory 920 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 930 may be a removable or non-removable medium, and may include a machine-readable medium such as a flash drive, a disk, or any other medium, which may be used to store information and/or data and may be accessed within the electronic device 900.

The electronic device 900 may further include additional removable/non-removable, volatile/non-volatile memory medium. Although not shown in FIG. 9, a disk drive for reading from or writing to a removable, non-volatile disk (such as a "floppy disk"), and an optical disk drive for reading from or writing to a removable, non-volatile optical disk may be provided. In these cases, each drive may be connected to a bus (not shown) by one or more data medium interfaces. The memory 920 may include a computer program product 925 having one or more program modules configured to perform various methods or acts of the various embodiments of the present disclosure.

The communication unit 940 enables communication with other electronic devices through a communication medium. Additionally, the functions of the components of the electronic device 900 may be implemented with a single computing cluster or multiple computing machines, which may communicate through a communication connection. Therefore, the electronic device 900 may use a logical connection with one or more other servers, a network personal computer (PC) or another network node to operate in a networked environment.

The input device 950 may be one or more input devices, such as a mouse, a keyboard, a tracking ball, etc. The output device 960 may be one or more output devices, such as a display, a speaker, a printer, etc. The electronic device 900 may also communicate with one or more external devices (not shown) as needed via the communication unit 940, the external devices such as a storage device, a display device, etc., communicate with one or more devices that enable a user to interact with the electronic device 900, or communicate with any devices (e.g., a network card, a modem, etc.) that enable the electronic device 900 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, which are executed by a processor to implement the method described above.

Various aspects of the present disclosure are described herein with reference to flowcharts and/or block diagrams of methods, apparatuses, devices and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general purpose computer, a special purpose computer, or other programmable data processing apparatus to produce a machine, such that the instructions, when executed by the processor of the computer or other programmable data processing apparatus, produce an apparatus for implementing the functions/acts specified in one or more blocks of the flowcharts and/or block diagrams. These computer-readable program instructions may also be stored in a computer-readable storage medium, which instructions cause a computer, a programmable data processing apparatus, and/or other devices to work in a particular manner, so that the computer-readable medium storing the instructions includes an article of manufacture including instructions for implementing various aspects of the functions/acts specified in one or more blocks of the flowcharts and/or block diagrams.

The computer-readable program instructions may be loaded onto a computer, another programmable data processing apparatus, or other devices, causing a series of operations and steps to be performed on the computer, other programmable data processing apparatus, or other devices, to produce a computer-implemented process, such that the instructions executed on the computer, other programmable data processing apparatus, or other devices implement the functions/acts specified in one or more blocks of the flowcharts and/or block diagrams.

The flowcharts and block diagrams in the drawings illustrate the architecture, functionality, and operation of possible implementations of the systems, methods and computer program products according to multiple implementations of the present disclosure. In this regard, each block in the flowchart or block diagrams may represent a module, a program segment, or a portion of instructions, which module, program segment, or portion of instructions contains one or more executable instructions for implementing the specified logical functions. In some updated implementations, the functions indicated in the blocks may also occur in an order different from that indicated in the drawings. For example, two consecutive blocks may actually be performed substantially in parallel, or they may sometimes be performed in the reverse order, depending upon the functionality involved. It also should be noted that each block of the block diagrams and/or flowcharts, and combinations of blocks in the block diagrams and/or flowcharts, may be implemented in special purpose hardware-based systems that perform the specified functions or acts, or may be implemented in a combination of special purpose hardware and computer instructions.

The implementations of the present disclosure have been described above. The above description is illustrative, not exhaustive, and is not limited to the disclosed implementations. Many modifications and variations will be apparent to those of ordinary skill in the art without departing from the scope and spirit of the described implementations. The choice of terms used herein is intended to best explain the principles of the implementations, the practical application, or improvements to the technology in the market, or to enable other ordinary skilled persons in the art to understand the implementations disclosed herein.

1. A method for information processing, implemented at a client device, the method comprising:
determining, from a first question-answering model local to the client device and a second question-answering model at a server device, a target question-answering model in response to obtaining a question message in a question-answering chat;
determining whether there is a set of historical messages in the question-answering chat that have not been synchronized to the server device in response to the second question-answering model being determined as the target question-answering model;
sending, in response to there being the set of historical messages that have not been synchronized, the question message and at least one of the set of historical messages to the server device, each historical message comprising a historical question message or a historical reply message in the question-answering chat, the historical reply message being generated by the first question-answering model based on a corresponding historical question message; and
receiving, from the server device, a reply message corresponding to the question message, wherein the reply message is determined by the second question-answering model based at least on the question message.

2. The method of claim 1, further comprising:
sending, to the server device, a client identification corresponding to each historical message in the set of historical messages in association with the question message and the at least one historical message.

3. The method of claim 2, wherein a message that has been synchronized to the server device has a server identification assigned by the server device and a client identification assigned by the client device.

4. The method of claim 3, wherein the client identification corresponding to each historical message in the set of historical messages is assigned based on the following:
assigning, based on a client identification corresponding to a historical message preceding the set of historical messages, the client identification corresponding to each historical message in the set of historical messages, wherein the historical message preceding the set of historical messages has been synchronized to the server device.

5. The method of claim 2, wherein a client identification assigned to the question message by the client device is sent to the server device together with the question message, and the method further comprises:
receiving, from the server device, feedback for the question message, the feedback comprising at least a server identification corresponding to the question message.

6. The method of claim 1, further comprising:
receiving, from the server device, a server identification assigned to the reply message in association with the reply message; and
assigning, using an identification generation policy, a client identification of the reply message based on the server identification of the reply message.

7. The method of claim 1, wherein the at least one historical message comprises at most a predetermined number of the most recent historical messages in the set of historical messages.

8. The method of claim 7, wherein the predetermined number is determined based on an amount of historical context information required by the second question-answering model.

9. The method of claim 1, further comprising:
sending, to the server device and in response to a communication between the client device and the server device being in an idle state, the set of historical messages or other historical messages in the set of historical messages than the at least one historical message, and a client identification corresponding to each historical message; and
receiving, from the server device, a server identification corresponding to each historical message in the set of historical messages.

10. The method of claim 1, wherein determining, from the first question-answering model local to the client device and the second question-answering model at the server device, the target question-answering model comprises:
determining, from the first question-answering model and the second question-answering model, the target question-answering model based on at least one of: a complexity of the question message, or a network communication capability between the client device and the server device.

11. A method for information processing, implemented at a server device, the method comprising:
receiving, from a client device, a question message in a question-answering chat and at least one of a set of historical messages in the question-answering chat, the set of historical messages having not been previously synchronized to the server device;
determining, by a second question-answering model at the server device, a reply message for the question message based on the question message and the at least one historical message; and
sending the reply message to the client device.

12. The method of claim 11, further comprising:
receiving, from the client device, a client identification corresponding to each historical message in the set of historical messages in association with the question message and the at least one historical message.

13. The method of claim 12, further comprising:
determining, in response to receiving the question message, a number of messages in the set of historical messages based on the client identification corresponding to each historical message in the set of historical messages;
assigning a server identification to the question message based on the number of messages and a server identification corresponding to a message that has been synchronized to the server device and that precedes the set of historical messages; and
sending, to the client device, feedback for the question message, the feedback comprising at least the server identification corresponding to the question message.

14. The method of claim 12, further comprising:
receiving, from the client device and in response to a communication between the client device and the server device being in an idle state, the set of historical messages or other historical messages in the set of historical messages than the at least one historical message and the client identification corresponding to each historical message;
determining an order of each historical message in the set of historical messages based on the client identification corresponding to each historical message in the set of historical messages;
assigning a server identification corresponding to each historical message to the set of historical messages based on the order; and
sending, to the client device, the server identification corresponding to each historical message in the set of historical messages.

15. The method of claim 14, wherein assigning the server identification corresponding to each historical message to the set of historical messages comprises:
assigning, based on a server identification corresponding to a historical message preceding the set of historical messages, the server identification corresponding to each historical message to the set of historical messages.

16. An electronic device, comprising:
at least one processor; and
at least one memory coupled to the at least one processor and storing instructions executable by the at least one processor, wherein the instructions, when executed by the at least one processor, cause the electronic device to perform operations comprising:
determining, from a first question-answering model local to the electronic device and a second question-answering model at a server device, a target question-answering model in response to obtaining a question message in a question-answering chat;
determining whether there is a set of historical messages in the question-answering chat that have not been synchronized to the server device in response to the second question-answering model being determined as the target question-answering model;
sending, in response to there being the set of historical messages that have not been synchronized, the question message and at least one of the set of historical messages to the server device, each historical message comprising a historical question message or a historical reply message in the question-answering chat, the historical reply message being generated by the first question-answering model based on a corresponding historical question message; and
receiving, from the server device, a reply message corresponding to the question message, wherein the reply message is determined by the second question-answering model based at least on the question message.

17. The electronic device of claim 16, wherein the operation further comprise:
sending, to the server device, a client identification corresponding to each historical message in the set of historical messages in association with the question message and the at least one historical message.

18. The electronic device of claim 17, wherein a message that has been synchronized to the server device has a server identification assigned by the server device and a client identification assigned by the electronic device.

19. The electronic device of claim 18, wherein the client identification corresponding to each historical message in the set of historical messages is assigned based on the following:
assigning, based on a client identification corresponding to a historical message preceding the set of historical messages, the client identification corresponding to each historical message in the set of historical messages, wherein the historical message preceding the set of historical messages has been synchronized to the server device.

20. The electronic device of claim 17, wherein a client identification assigned to the question message by the electronic device is sent to the server device together with the question message, and the operations further comprise:
receiving, from the server device, feedback for the question message, the feedback comprising at least a server identification corresponding to the question message.
